(19) United States
(12) Patent Application Publication
(10) Pub. No.: US 2024/0138464 A1
(43) Pub. Date: May 2, 2024

(54) SYSTEM AND METHOD FOR OPTIMIZING JUICE PRESS CUT PRODUCTION

(71) Applicant: G3 Enterprises, Inc., Modesto, CA (US)

(72) Inventors: Federico Olivi, Lugo (IT); Lucia Bilro, Ílhavo (PT); Rogério Nogueira, Vagos (PT); Carlos Baradello, Tiburon, CA (US); John Cunningham, Tracy, CA (US)

(21) Appl. No.: 18/499,898

(22) Filed: Nov. 1, 2023

Related U.S. Application Data
(60) Provisional application No. 63/421,481, filed on Nov. 1, 2022.

(51) Int. Cl. A23N 1/00; B30B 9/02; B30B 15/16; B30B 15/26; C12G 1/00

(52) U.S. Cl. CPC A23N 1/00; B30B 9/02; B30B 15/168; B30B 15/26; C12G 1/00

(57) ABSTRACT

Described herein, in some embodiments, are systems and methods for optimizing a press cycle for producing one or more press cuts from a harvested fruit/vegetable. In some embodiments, optimizing the press cycle includes optimizing the quality of the juice by identifying and controlling specific pressing parameters to produce the maximum volume of the highest quality juice for every press cut identified by the system and/or the individual components responsible for the juice production. The system might identify the pressing factors for optimum performance using historical juice data from current and prior harvests, laboratory results from the actual juice analysis, other current or past harvest data, and information from juice post processing that are integrated into mathematical models enabling the system and/or process owners to predict certain finished product characteristics from the pressing operations.

### CROSS-REFERENCE

This application claims the benefit of and priority to U.S. Patent Application No. 63/421,481, titled “System and Method for Optimizing Juice Press Cut Production,” and filed Nov. 1, 2022, which is incorporated herein by reference in its entirety.

### BACKGROUND

The extraction of juice from fruits and vegetables is an important process for many industries. This process is clearly vital to the production of wine. Winemakers manage the extraction of the juice from fruit (e.g., grapes) as a determinant factor of the final characteristics of the finished product including, for example, color, acidity, and phenolics levels. The extraction of juice using presses, such as a pneumatic press, share similar operational characteristics which can be programmed according to defined recipes to produce specific juice attributes. In the wine industry, winemakers have traditionally defined a “press recipe” based on experience, grape varietal, as well as the qualitative and quantitative objectives of the desired final wine product. These traditional press recipes, however, do not account for the high variability of the incoming fruit which changes significantly across varietal, and vineyard locations, due to weather, time of harvest, and/or other factors.

### SUMMARY

Disclosed herein, in some aspects, is a system for optimizing a press cycle for producing one or more press cuts from a fruit and/or vegetable harvest, the system comprising: a press configured to extract a fluid from a batch of a fruit and/or vegetable harvest; a flow path in fluidic communication with the press and configured to receive the extracted fluid; one or more flow sensors disposed within and/or about the flow path and configured to detect and obtain measurements of one or more parameters of the extracted fluid; and at least one processor in operative communication with the one or more flow sensors and configured to determine, based on the measurements, at least one of: i) that a threshold value corresponding to a press cut segregation point has been reached, or ii) one or more conditions for operating the press to produce at least one press cut.

Disclosed herein, in some aspects, is a method for optimizing a press cycle for producing one or more press cuts from a fruit and/or vegetable harvest, the method comprising: using a press to extract a fluid from a batch of a fruit and/or vegetable harvest; receiving the extracted fluid within a flow path in fluidic communication with the press; measuring one or more parameters in the extracted fluid using one or more flow sensors; providing the measurements of the one or more parameters to at least one processor; and determining, using the at least one processor and based on the measurements, at least one of: i) that a threshold value corresponding to a press cut segregation point has been reached, or ii) one or more conditions for operating the press to produce at least one press cut.

### BRIEF DESCRIPTION OF THE DRAWINGS

These and other features, aspects, and advantages of some embodiments will become better understood with regard to the following description and accompanying drawings.

Figure (FIG. 1 depicts a system environment overview for optimizing a press cycle for producing one or more juice press cuts, in accordance with an embodiment.

FIG. 2 depicts an exemplary press outlet pipe having sensors for receiving and measuring parameters of juice extracted from a press, in accordance with an embodiment.

FIG. 3 depicts exemplary parameters of the juice extract and conditions of the press, as detected by the sensors and read from the press, sent from the sensor system and press to the cloud for storage and processing and then sent to a dashboard for review and action, in accordance with an embodiment.

FIG. 4 depicts an exemplary computer system, in accordance with an embodiment.

FIG. 5 depicts an exemplary predicted phenolic concentration using a system described versus the lab detected phenolic concentration, in accordance with an embodiment.

FIG. 6 depicts a dashboard display comparing juice parameters and press conditions during two exemplary press runs, and corresponding setpoints for press cuts, in accordance with an embodiment.

FIG. 7 depicts an exemplary flow chart for a method of optimizing a press cycle, in accordance with an embodiment.

### DETAILED DESCRIPTION

### I. Definitions

Terms used in the claims and specification are defined as set forth below unless otherwise specified.

In various examples, the term “press cycle” as used herein refers to pressing a batch of a fruit and/or vegetable harvest to extract a juice from the fruit and/or vegetable. The pressing is performed using a press that receives the batch and presses the fruit and/or vegetable using a predefined recipe that can include the application of specific pressures for prescribed times, for example, by applying pressure on the fruit and/or vegetable using a membrane (e.g., for a pneumatic press), with the pressure increasing steadily or in a stepwise fashion according to pre-determined intervals and increasing to a pre-determined threshold. Other types of presses may be used for any system and method described herein.

In various examples, the term “press cut”, “fruit press cut”, “juice press cut”, “fruit juice press cut”, “wine press cut”, and “portion of the juice extract” may be used interchangeably herein. The term “press cut” refers to different and/or sequential portions of the juice extracted from a batch of a fruit and/or vegetable harvest using the press. The press cycle helps enable extraction of the juice for the later portions (or later wine press cuts), which may require, for example, increasing pressure to extract juice from certain parts of the fruit (e.g., an inner portion of a grape as opposed to a pulp portion of a grape where juice is easily extracted). In some cases, the different fruit juice press cuts (e.g., wine press cuts) have different properties, for example, as the pressing pressures increase phenolic concentrations typically increase. Accordingly, in some cases, a final product may include a blend of different portions of the juice extract (or press cuts) to attain a desired combination of taste, aroma, mouthfeel, and/or other characteristics. In certain implementations, a pressing operation for a batch of fruit or vegetables can produce multiple press cuts, for example, with one press cut including juice produced during a beginning of the pressing operation and another press cut including juice produced during an end of the pressing operation.

In various examples, the term “press recipe” refers to conditions specified for a press to operate so as to produce a desired juice quality and/or juice volume in a desired time (e.g., for the fruit mass pressed). In some cases, the conditions vary over the press cycle to produce the different press cuts (e.g., by varying (e.g., increasing or decreasing) the pressure in the press). Other conditions include pressure hold times, rotation intervals (e.g., time between instances when a press component is rotated), and/or size of pressure increase increments. In certain implementations, the press recipe can be or include a sequence of operating conditions (e.g., pressures, rotation speeds, displacements, etc.) used by a press during a pressing operation. The press recipe can be implemented and/or adjusted according to sensor measurements, as described herein.

In various examples, the term “fruit harvest” refers to a fruit or vegetable recovered or obtained (e.g., picked) from a field, from which one or more batches may be loaded into a press for extracting a juice. The fruit harvest may be or include, for example, any fruit or vegetable used for wine production, fruit juice production, vegetable juice production, or spirits production. For example, the fruit or vegetable may be grapes, plum, pomegranate, wine, pumpkin, kiwi, potatoes, carrots, strawberry, raspberry, blueberry, other berries, or any combination thereof. As used herein, the term “fruit” may include any fruit and/or any vegetable.

In various examples, the term “juice extract” refers to the juice obtained from the fruit and/or vegetable harvest in the press. The juice extract may include “free run” juice or other juice that is obtained prior to a press cycle beginning, and/or may include juice obtained after a press cycle has begun. The juice extract may be a fluid and/or may be or include a pure liquid phase, a liquid-solid mixture, a liquid-solid-gas mixture, or a combination thereof.

It must be noted that, as used in the specification, the singular forms “a,” “an” and “the” include plural referents unless the context clearly dictates otherwise.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of”

### H. System Environment Overview

Described herein, in some embodiments, are systems and methods for optimizing a press cycle for producing one or more juice press cuts from a fruit and/or vegetable harvest. In some embodiments, optimizing a press cycle includes optimizing the pressing efficiency by minimizing the time and/or maximizing the juice volume per unit mass pressed. In further embodiments, optimizing the press cycle includes optimizing the quality and/or composition of the juice, for example, by identifying and controlling specific pressing parameters to produce the maximum volume of the highest quality juice (e.g., extracted juice) for every press cut identified by the system and/or the individual components responsible for the juice production. The system might identify the pressing parameters (e.g., pressing factors) for optimum performance using historical juice data from current and prior harvests, laboratory results from the actual juice analysis, other current or past harvest data (which may include, for example, fruit or vegetable characteristics prior to extraction (e.g., prior to being pressed), which may be based at least partly on weather, environmental, and other conditions as known in the art), and information from extracted juice post processing that are integrated into mathematical models, enabling the system and/or process owners to predict certain finished product characteristics from the pressing operations.

In some embodiments, optimizing a press cycle can be done by identifying specific parameter thresholds for juice extract from a fruit and/or vegetable press being met, and/or by determining one or more operating conditions for a press cycle (for the press). In some embodiments, the one or more conditions (operating conditions) for the press cycle are automatically determined and/or recommended by a system described herein based on one or more parameters detected in the juice (extracted from the fruit and/or vegetable harvest). In some embodiments, the system automatically determines adjustments to the one or more conditions for the press cycle based on changes detected to the one or more parameters in the juice extracted. In some embodiments, the one or more conditions for the press cycle are determined in real-time with or without human intervention (e.g., automatically).

FIG. 1 depicts an overview of an exemplary system 100 for optimizing a press cycle. In some embodiments, the system includes a flow path 102 in fluid communication with a press 110, such that the flow path 102 is configured to receive extracted juice from a fruit and/or vegetable harvest, as described herein (e.g., juice extracted from a batch of a fruit and/or vegetable harvest via the press 110). In some embodiments, the flow path 102 is provided via a pipe, a tube, a duct, a container, or any combination thereof, any of which may be coupled to the press 110. In some embodiments, the flow path 102 is separable from a flow path network that transfers the juice extract from the press 110 to a receiver, such as a container for storing the juice extract. For example, in some cases, the flow path is provided as a segment of pipe 104 in a piping system.

In some embodiments, the system 100 comprises one or more sensors 106 (e.g., one or more flow sensors 106) configured to detect a parameter of the juice extract. In some embodiments, each sensor 106 is configured to detect at least one parameter. In some embodiments, the one or more sensors 106 comprise: i) a conductivity sensor for measuring the conductivity in the juice extract, ii) a pH sensor for measuring the pH in the juice extract, iii) a redox sensor for measuring the oxidizing and/or reducing potential of the juice extract, iv) a turbidity sensor for measuring the turbidity of the juice extract (e.g., which can be correlated to an amount of suspended solids in the juice extract), v) a color sensor for measuring a color of the juice extract, vi) a flow meter for detecting a flow rate of the juice extract through the flow path 102, vii) a thermometer or thermocouple for measuring temperature, viii) a phenolics concentration sensor (e.g., a chromatography sensor or an electrochemical sensor), ix) a dissolved oxygen sensor, x) a brix degree sensor (e.g., a refractometer or a hydrometer), xi) any other sensor known in the art, or xii) any combination thereof. In some embodiments, the turbidity sensor and the color sensor may be combined into a single sensor. In some embodiments, any number of parameters may be detected using a single sensor. In other embodiments, one or more other sensors may be substituted or included to meet the desired requirements of the final product depending on the fruits or vegetables used.

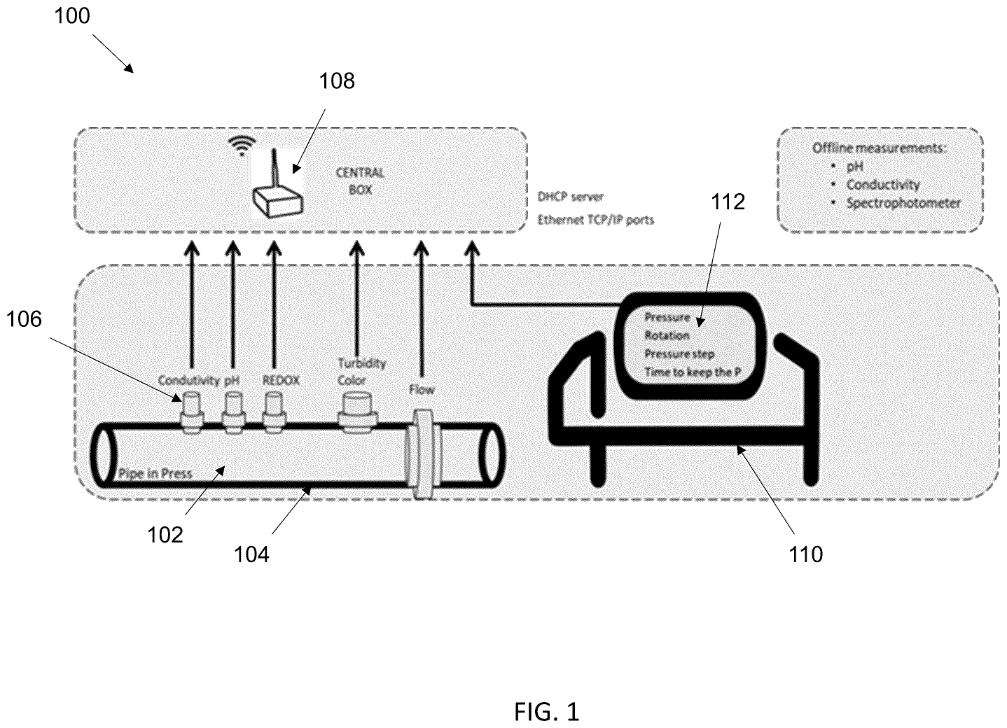

In some embodiments, the one or more sensors 106 are configured to measure the parameters of the juice extract in real-time and within the flow path 102. In some embodiments, at least a portion of a sensor 106 or a measuring component of a sensor 106 is located within the flow path 102. In some embodiments, at least a portion of a sensor or a measuring component of a sensor 106 is configured to contact the juice extract in the flow path 102. In some embodiments, at least one sensor 106 is coupled to a wall defining the flow path 102, such as a wall of the pipe 104. FIG. 2 depicts an exemplary image of a pipe segment configured to receive juice extract from a press, as described herein, wherein a plurality of sensors 106 is coupled to the pipe 104 and configured to measure corresponding parameters of the juice extract that flows from the press and through the pipe 104.

In some embodiments, the system 100 comprises one or more processors 108 (alternatively referred to herein as “processor 108”) in operative communication with the one or more sensors 106, and configured to receive the measured parameters (e.g., configured to receive data correlating to the measured parameters). Additionally or alternatively, the one or more processors 108 can be configured to receive one or more parameters that are manually measured (e.g., by an operator, user, winemaker, or other personnel) and provided to the processor via a local or remote user interface (e.g., using a keyboard, mouse, dashboard, a software application, an app, and/or a wired or wireless device connected to the Internet). For example, an operator may use a pH sensor to measure pH and may provide the measured value to the one or more processors 108 by entering the value via a keyboard, smartphone, or other input device.

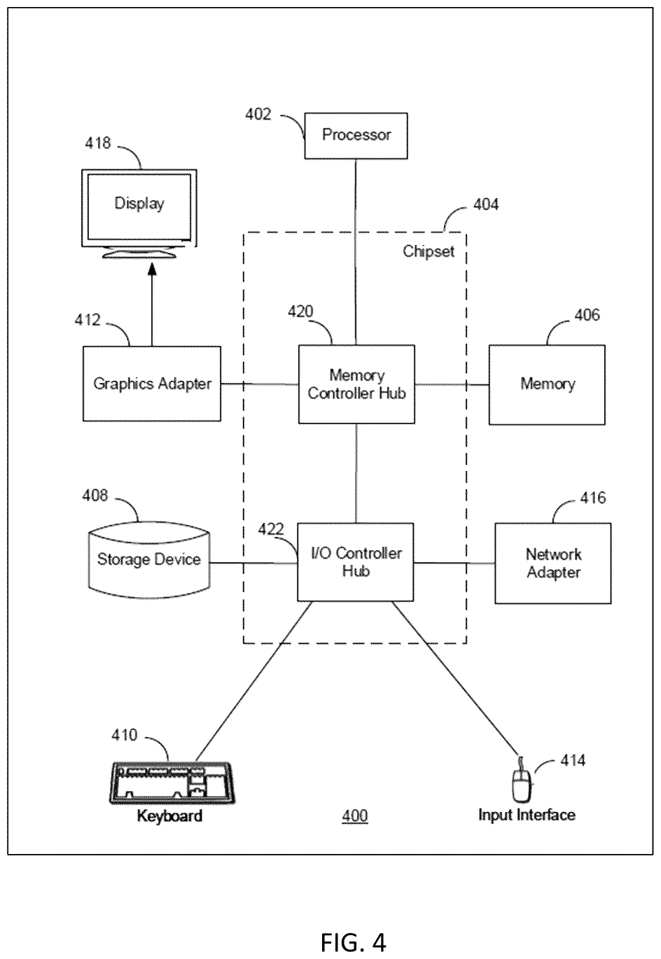

As described herein, and as depicted in FIG. 4 as an exemplary computer system, the one or more processors 108 may utilize or include one or more computing devices, one or more storage components, one or more interfaces for input and/or output functions, etc. In some embodiments, the one or more processors 108 may utilize or include a cloud computing system.

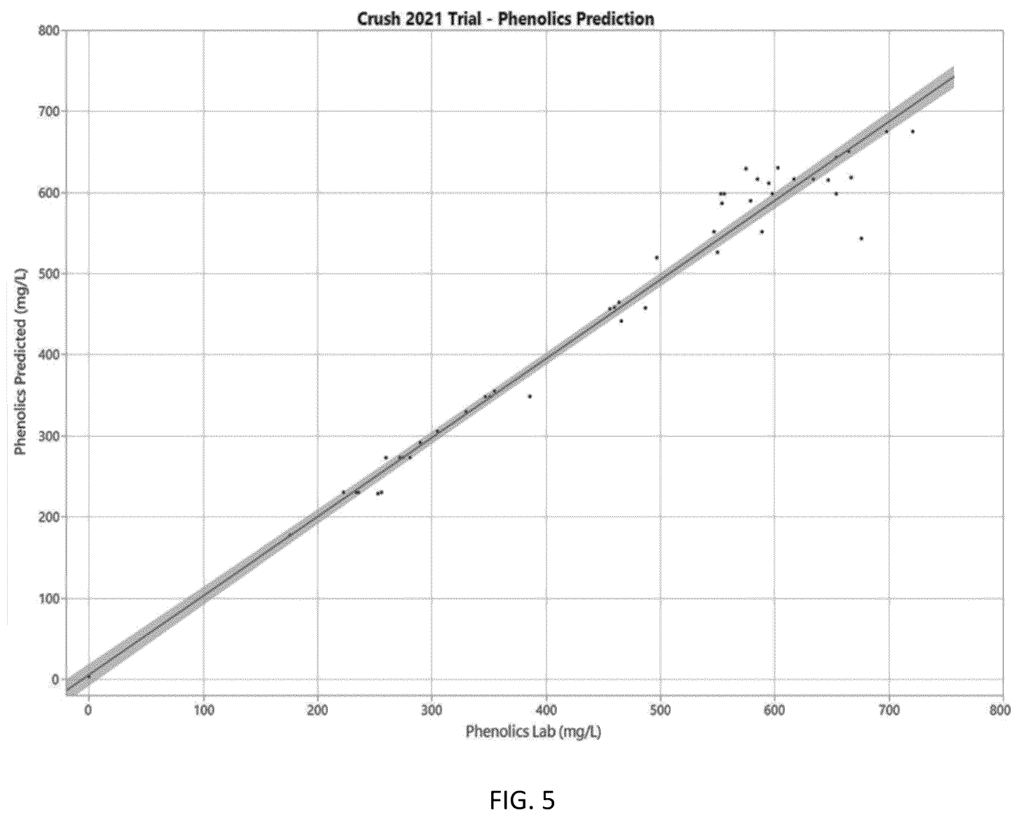

In some embodiments, the one or more processors 108 can be configured to process one or more of the received measured parameters (e.g., data corresponding to values of the received measured parameters) to determine another parameter of the juice extract. In some embodiments, the processor 108 is configured to determine a chemical quality or composition of the juice extract. For example, in some embodiments, the processor is configured to determine (e.g., using a mathematical model) a phenolic concentration of the juice extract based on the one or more measured parameters (e.g., conductivity, pH, redox, and/or turbidity). FIG. 5 provides a graphical comparison of the phenolic concentration of a juice extract (y-axis) as determined via a mathematical model from juice parameters measured by the system sensors (e.g., in communication with the one or more processors 108), and the phenolic concentration of the same juice extract as determined via a laboratory analysis (e.g., using chromatography or similar methods or equipment that can measure phenolic concentration). As depicted, the phenolic concentrations determined by the one or more processors 108 are similar to those determined in the laboratory analysis. In other embodiments, historical data from prior harvests can be used to predict other parameters of the juice or the finished product. In certain examples, the mathematic model used to determine phenolic concentration from the measured parameters can be or include an empirical model, a machine learning model, or other predictive model.

Referring again to FIG. 1, in some embodiments, the processor 108 is configured to determine a solid content in the juice extract, and/or determine an increasing or varying solid content in the juice extract. In some embodiments, the processor 108 is configured to identify one or more abnormalities associated with the juice extract. For example, in some embodiments, the processor 108 is configured to determine when the juice extract has high microbiological levels/concentrations based on one or more sensor readings. In some embodiments, the processor 108 is further configured to determine how to help correct, alleviate, or mitigate the abnormality. For example, in the case of the processor 108 identifying the juice extract as having a high microbiological count, the processor may indicate (e.g., via a user interface, such as display, dashboard, and/or microphone) that an increased quantity of sulfur dioxide should be injected into the juice extract. For example, in some cases sulfur dioxide, in liquid and/or powdered form (e.g., meta bisulfate), can be added at a particular stage in the process, such as when a batch of the fruit and/or vegetable harvest is being destemmed, crushed, and/or pressed (including, for example, when pressing full bunches in the press 110). In some embodiments, the amount of sulfur dioxide added is from about 1 g/hl to about 5 g/hl (e.g., of the juice extract), such as about 3 g/hl. In some embodiments, the sulfur dioxide is added to the juice extract in the flow path 102.

In some embodiments, the processor 108 is configured to receive one or more conditions of a press cycle for the press 110 (e.g., operating conditions for the press during the press cycle). In some embodiments, the processor 108 receives the one or more conditions of the press cycle via operative communication with one or more press sensors 112 (e.g., sensors configured to detect or measure conditions and/or changes in the press 110). In some embodiments, the system 100 comprises the one or more press sensors. In some embodiments, the one or more conditions include a pressure applied by the press 110 during the press cycle, a rotation speed and/or rotation interval of the press 110, size of incremental pressure increase (e.g., throughout the press cycle), a duration of a pressure being maintained during the press cycle, or any combination thereof.

In some embodiments, the processor 108 is configured to receive and store (e.g., in a local storage device or a remote storage device) the one or more parameters and/or the one or more conditions of a press cycle for future processing.

In some embodiments, the press 110 comprises any press known in the art. In some embodiments, the press 110 is or includes a pneumatic press, a hydraulic press, a mechanical press, a centrifuge system, racking tank to tank, or any combination thereof. The press 110 can extract a juice from a fruit or vegetable by pressing or squeezing the fruit or vegetable at elevated pressure. Alternatively or additionally, the press 110 can extract the juice by stirring, mixing, and/or shearing the fruit or vegetable, for example, using a rotational feature or component. The pressure, rotation, or other operating condition applied by the press 110 when extracting the juice can be defined by the press recipe and/or can be controlled by the processor 108 and/or a control system, as described herein.

### Optimizing a Press Cycle

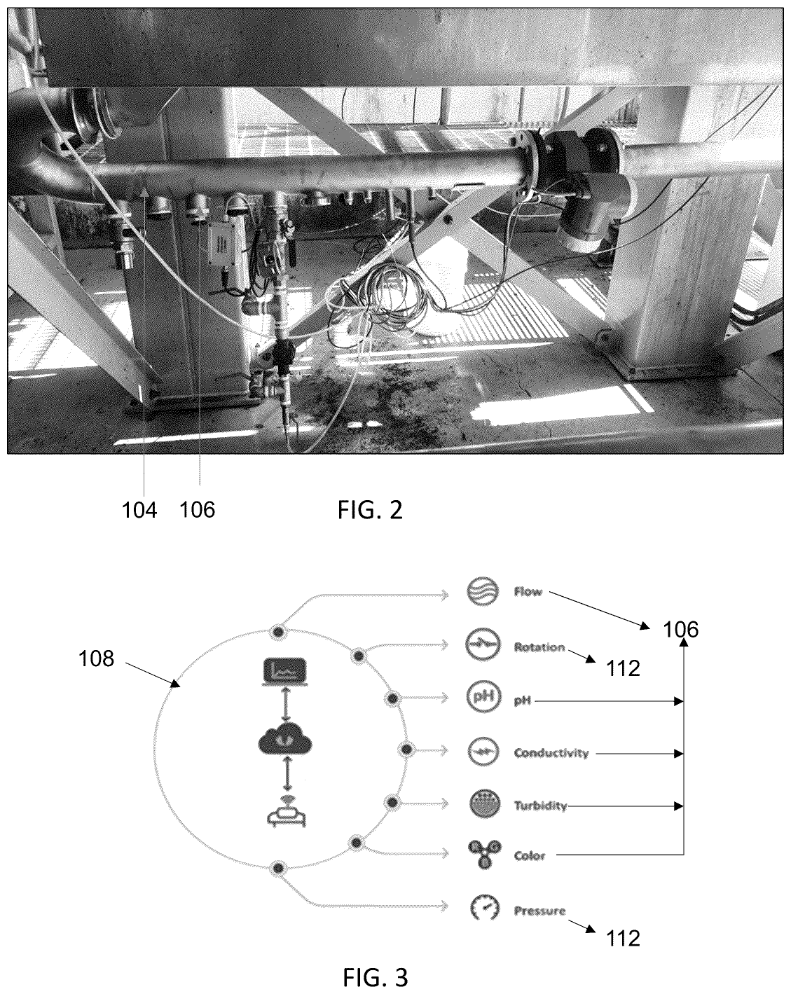

FIG. 3 provides an exemplary depiction of the processor 108 (e.g., as part of a cloud computing environment) in operative communication with the one or more flow sensors (e.g. sensors 106 in FIG. 1) and one or more press sensors (e.g., press sensors 112 in FIG. 1), wherein parameters and conditions are received, stored (e.g., in the cloud or local storage), and in some cases used for determining adjustments to the conditions to optimize a press cycle. As described herein, in some embodiments, a press recipe is assigned for a fruit and/or vegetable harvest to specify desired press cuts from the extracted juice. In some cases, the press cuts represent different and/or sequential portions of the juice extracted from a fruit and/or vegetable harvest. In some cases, the press cycle helps enable the extraction of the latter portions of the juice (or later press cuts), wherein increasing pressure (over the press cycle, for example) may be required to continue to extract juice from certain portions of the fruit (e.g., inner portion of a grape as opposed to a pulp portion of a grape where the juice is easily extracted). In some embodiments, the conditions (e.g., of the press as described herein) are used to correlate or determine segregation points (e.g., starting or ending points) between press cuts. Accordingly, in some embodiments, the press recipe comprises identifying different press cuts based on different pressures applied by the press (e.g., “press pressure”). In some cases, the different press cuts (of extracted juice for example) have different properties, for example, an increasing phenolic concentration or decreasing turbidity (e.g., as more juice is extracted from a batch). Accordingly, in some cases, a final product may include a blend of different portions (or press cuts) to attain, for example, a prescribed taste, aroma, or other desired characteristics of the final product.

Conditions of the press can be measured using one or more press sensors. The press sensors can include, for example, one or more sensors for measuring a position or displacement of a press component, an acceleration of a press component, a velocity of a press component, a temperature in the press, a pressure in the press, and/or a property of a material (e.g., a fruit or juice) in the press.

In some embodiments, as described herein, a press recipe is initially assigned for a fruit and/or vegetable harvest, which may be based on factors for the fruit and/or vegetable harvest. For example, for grapes, exemplary factors can include: the vineyard where the fruit was harvested, the date when the fruit was harvested, the time the fruit spent in trailer containers or gondolas, the time between harvesting and pressing, the temperature of the fruit, exposure to oxygen prior to pressing, and/or any other factors that could impact juice quality. In some embodiments, the press recipe is alternatively or additionally configured based on experience by the operator (e.g., winemaker, user, or other personnel). For example, a taste test may help the operator determine an initial press recipe for the fruit or vegetable harvest.

Referring to FIGS. 1 and 3, in some embodiments, the press recipe is communicated to the processor 108 (e.g., via a local or remote user interface such as a keyboard, and/or via communication with a control system of the press). In some embodiments, once juice from a fruit or vegetable harvest begins to be extracted from the press 110, the one or more sensors 106 provide real-time measurements of the parameters of the juice extract to the processor 108. In some embodiments, as described herein, the processor 108 processes the parameters to determine additional parameters of the juice extract, such as phenolic concentration.

In some embodiments, the processor 108 is configured to optimize a press cycle by automatically determining a press recipe for producing one or more press cuts. In some embodiments, the processor 108 determines the press recipe using the one or more parameters of the juice extract (measured using the flow sensors 106), and/or one or more parameters of the juice extract as determined using the measured parameters (for example, phenolic concentration determined using the measured parameters). For example, in some embodiments, a pH of the juice extract is specified as a parameter for determining a press cut, where the pH may be from about 2.5 to 4.5, such as from about 3 to 4. In some embodiments, the phenolic concentration is specified as a parameter for determining a press cut, where the phenolic concentration may be from 0 to about 20,000 mg/1, such as 0 to about 15,000 mg/1, 0 to about 10,000 mg/1, 0 to about 5,000 mg/1, and/or 0 to about 1,000 mg/l. In some embodiments, the press recipe is based on one or more of the measured parameters. For example, press cuts can be specified according to a threshold value of a parameter being met.

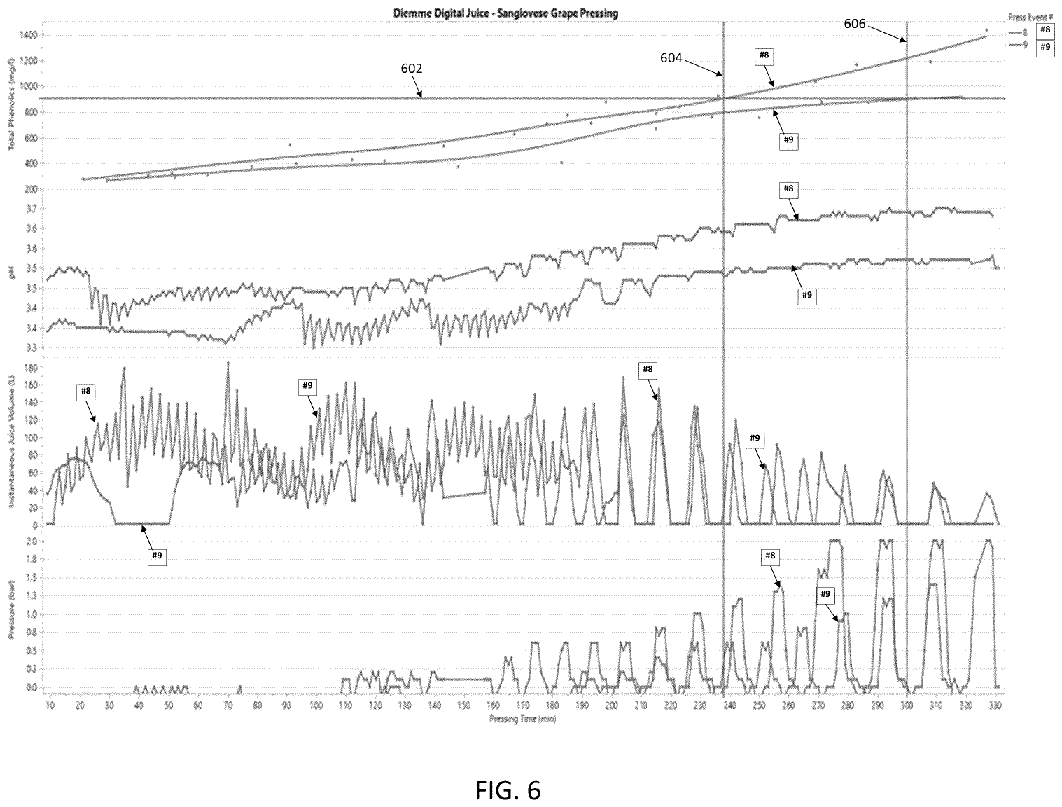

For example, FIG. 6 depicts an exemplary comparison of two batches of Sangiovese grapes being pressed in a press, where the two batches are identified as press event #8 and press event #9. The figure presents parameters for the juice extract and the press over time, during the press events. The parameters of the juice extract depicted include the phenolic concentration, the pH, and the instantaneous volume, while the corresponding pressure of the press (bladder pressure) is also depicted. Here, a press cut (e.g., wine press cut) can be specified to begin or end (e.g., at a press cut segregation point) when the juice extract reaches a threshold value 602 corresponding to a total phenolic concentration of 900 mg/L. For press event #8, this total phenolic concentration occurs at a segregation point 604, when the pH is about 3.6 and the pressure is about 1.0 bar. By contrast, for press event #9, this total phenolic concentration occurs at a segregation point 606, when the pH is about 3.5 and the pressure is about 1.2 bar. Thus, a predetermined press recipe specifying a press pressure of 1.0 bar or 1.2 bar for both batches of the grape harvest (press event #8 and #9) could produce juice cuts of different quality or composition. In some examples, the same grape harvest may have fruits of different quality, and thus predetermined press recipes based on a generalized understanding and/or history of a fruit characteristic may result in skewed or inconsistent juice cuts.

In some embodiments, as described herein, the system is configured to identify one or more press cuts for a fruit and/or vegetable harvest based on prescribed threshold values for one or more parameters of the juice extract (e.g., measured by or determined using the one or more sensors 106). In some embodiments, the processor is configured to receive from a user (or operator, winemaker, or other personnel) one or more threshold values for one or more parameters of the juice extract. In some embodiments, the one or more threshold values of the juice extract comprise pH, dissolved oxygen, brix degree, turbidity, total polyphenols (phenolic concentration), conductivity, color, any other parameter known in the art, or any combination thereof. In some embodiments, the pH and/or the phenolic concentration are used for optimizing a press cycle.

In some embodiments, in addition to or alternative to receiving threshold values from an operator specifically, the threshold values a press cut can be determined by the processor using a machine learning algorithm. For example, in some embodiments, based on the characteristics of the fruit or vegetable harvest (e.g., type, date of harvesting, fermentation, etc.), the processor 108 correlates historical data (e.g., stored in a memory storage) relating to press cuts (e.g., wine cuts) for relevant fruit or vegetable harvests (e.g., similar types of fruit or vegetable harvests). For example, in some embodiments, the historical data may include a quality of the wine press cuts based on the corresponding parameters of the juice extract, such that the processor 108 is configured to identify an optimal press recipe (based on specified threshold values) for the given fruit or vegetable harvest. In some embodiments, the processor is configured to receive feedback relating to one or more parameters falling outside a prescribed range based on the applied threshold values, such that the machine learning algorithm stores parameters with the historical data so as to account for differences in the specific fruit or vegetable harvest (e.g., a different conductivity, phenolic concentration, pH, etc.) in future press runs. In some embodiments, the historical data includes one or more conditions of the press (e.g., press pressure), as described herein. In some embodiments, the processor is configured to receive feedback relating to one or more of historical juice data from current and prior harvests, laboratory results from the actual juice analysis, other current or past harvest data (which may include, for example, fruit or vegetable characteristics prior to extraction, which may be based at least partly on weather, environmental, and/or other conditions known in the art), and information from juice post processing (that may be integrated into mathematical models), such that the machine learning algorithm stores parameters with the historical data so as to account for differences in the specific fruit or vegetable harvest in future press runs. In various examples, the machine learning algorithm uses a model configured to receive as input one or more parameters related to the fruit harvest (e.g., fruit type and condition) and provide as output one or more thresholds (e.g., pressure, conductivity, total phenolic concentration) that can be used to define a starting point or an ending point of a press cut during a pressing operation. The model can be trained to determine the one or more thresholds according to historical data, as described herein.

In some embodiments, the processor 108 is configured to monitor the parameters of the juice extract in real time (e.g., based on sensor measurements), and indicate when a press cut threshold value has been attained. For example, in some embodiments, the processor is configured to provide an alert, a control signal, or other signal, indicating that a press cut threshold has been attained. In some cases, once the threshold is reached, the juice extract can be sent to a different location (e.g., a different barrel) for the next press cut. In some cases, the juice extract is diverted to a different tank, where the juice extract may automatically diverted. In various examples, the processor 108 can form part of a control system that is used to implement a press recipe and/or take action when a threshold is reached.

In some embodiments, the processor 108 is configured to automatically determine one or more conditions of the press as part of a press recipe for a fruit and/or vegetable harvest to achieve desired press cuts. For example, in some embodiments, the processor is configured to automatically adjust an existing press recipe (specifying one or more conditions of the press 110) so as to obtain juice cuts having desired parameter threshold values. In some embodiments, the desired parameter threshold values correspond to one or more juice quality characteristics. With reference to FIG. 6, for example, if a press recipe specified a wine cut at 1.2 bar, the processor 108, in detecting the increasing phenolic concentration in press event #8, may adjust the press recipe to lower the press pressure (e.g., 1.0 bar) at which a wine cut is made, so as to obtain a phenolic concentration of about 900 mg/L. Accordingly, in some embodiments, the processor 108 is configured to automatically determine an adjustment to one or more conditions (e.g., operating conditions) of the press in real-time based on real-time monitoring of any combination of the parameters for a juice extract. In some embodiments, the adjustment to the one or more conditions is based on a correlation with historical data and/or is obtained using a machine learning algorithm.

As described herein, in some embodiments, the processor 108 is configured to automatically determine an adjustment to the conditions of a press so as to achieve one or more juice press cuts. In some embodiments, the processor is configured to determine an adjustment to a current set of conditions of the press (for a current press cut), and/or configured to determine an adjustment to a future set of conditions of the press, for future press cuts. In some embodiments, the adjustment to the one or more conditions comprises various conditions correlating with a corresponding segregation point between juice press cuts.

In some embodiments, as described herein, the processor is configured to alert or otherwise provide a signal to the operator or user regarding an adjustment to one or more conditions of the press.

### III. Methods for Optimizing a Press Cycle

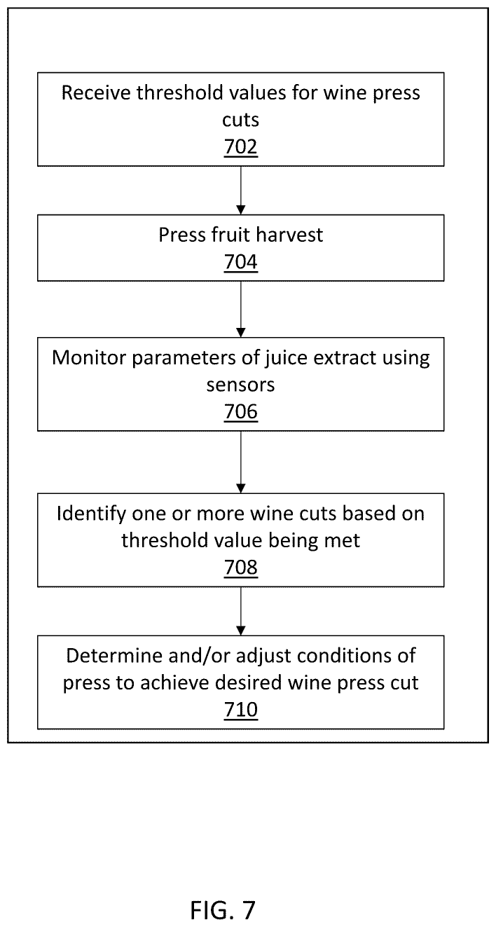

Embodiments described herein include methods for optimizing a quality and/or efficiency of a press cycle through real-time monitoring of one or more parameters of a juice extract recovered through pressing of the fruit. Such methods may include using the system as described herein, such as system 100 in FIG. 1. FIG. 7 depicts an exemplary flow diagram for optimizing a press cycle, wherein wine cuts are identified according to specified parameter threshold values, in accordance with an embodiment. In some embodiments, a processor (e.g., 108) first receives 702 threshold values for one or more parameters of the juice extract that correlate with a desired characteristic for one or more wine press cuts. In some embodiments, the threshold values are inputted by an operator (or other personnel). In some embodiments, the threshold values are determined by the processor using historical juice data from current and prior harvests, laboratory results from the actual juice analysis, other current or past harvest data (which may include, for example, fruit or vegetable characteristics prior to extraction, which may be based at least partly on weather, environmental, and other conditions as known in the art), and/or information from juice post processing (that may be integrated into mathematical models), as described herein, and/or may be determined using a machine learning algorithm or model. In some embodiments, the fruit or vegetable harvest is then pressed 704 in the press, thereby extracting juice from the fruit and/or vegetable and sending the juice to a flow path (e.g., 102). In some embodiments, one or more sensors (e.g., 106) are used to measure one or more parameters of the juice extract in real-time, wherein the sensors are in operative communication with the processor, which monitors 706 said parameters. In some embodiments, the processor then identifies 708 that one or more threshold values of the parameters have been met, and in response generates an alert for a control system, a press operator, a product manager, a technical lead, or other personnel. The alert can be acted upon manually by press personnel or automatically using system controls including pump and/or valve actuations. In some cases, said threshold value identifies a press cut segregation point between the current press cut and the next press cut. In some embodiments, the press cut comprises a single press cut, defined based on the specified parameters of the juice extract.

In some embodiments, the processor optionally and automatically determines 710 one or more conditions at which the press should operate in order to achieve one or more desired press cuts. As described herein, in some embodiments, the press conditions for a press cycle (e.g., press recipe) are initially set based on the fruit or vegetable harvest conditions and/or characteristics (e.g., type of fruit, date of harvest, time since harvest, etc.), fruit growing conditions (e.g., when data is available), which may include information such as fertilizer, irrigation, weather, and so on, and/or experience of the operator (e.g., personnel, winemaker, etc.). Additionally or alternatively, in some instances, one or more predictive models (e.g., machine learning models) can be used to determine an initial set of operating conditions for the press cycle (e.g., the press recipe). In some embodiments, the processor, having received the press recipe (e.g., via the operator, or via a control system in communication with the processor), is configured to determine in real-time one or more adjustments to the press recipe based on the parameters of the juice extract, so as to achieve the desired press cut(s). In some embodiments, the processor is configured to output and/or alert the operator of the adjustments to the press conditions (e.g., adjustments to pressure, rotational speed, incremental step increase of the pressure, dwell time of a given pressure, or any combination thereof). In some embodiments, the processor is configured to determine the adjustment to the press conditions using a machine learning algorithm or model, taking into account historical data (in communication with the processor) of past press cycles and press cuts (e.g., wine press cuts) produced. In some embodiments, the historical data includes a quality or composition of past press cuts (e.g., wine press cuts) produced. The historical data can be used to train a machine learning model to determine or identify optimal press conditions based on given juice or press parameters (e.g., obtained from sensor measurements) and/or factors of a fruit and/or vegetable harvest. In some embodiments, the processor is configured to determine the adjustment to the press conditions using a machine learning algorithm or model, taking into account historical juice data from current and prior harvests, laboratory results from the actual juice analysis, other current or past harvest data (which may include, for example, fruit or vegetable characteristics prior to extraction, which may be based at least partly on weather, environmental, and other conditions as known in the art), and information from juice post processing (that may be integrated into mathematical models).

In some embodiments, steps 702 and/or 708 are optional and step 710 can be used to control the press cycle according to sensor measurements. For example, the processor can receive measurement data for the juice and/or press and can use the measurement data to control the press to achieve the desired press cuts, with or without any threshold values being specified.

### IV. Computer Implementation

The methods described herein, including the methods of implementing one or more processors for optimizing a press cycle, are, in some embodiments, performed on one or more computers and/or computational platforms.

For example, the building and deployment of any method described herein can be implemented in hardware or software, or a combination of both. In one embodiment, a machine-readable storage medium is provided, the medium comprising a data storage material encoded with machine readable data which, when using a machine programmed with instructions for using said data, is capable of executing any one of the methods described herein and/or displaying any of the datasets or results described herein. Some embodiments can be implemented in computer programs executing on programmable computers, comprising a processor and a data storage system (including volatile and non-volatile memory and/or storage elements), and optionally including a graphics adapter, a pointing device, a network adapter, at least one input device, and/or at least one output device. A display may be coupled to the graphics adapter. Program code is applied to input data to perform the functions described above and generate output information. The output information is applied to one or more output devices, in known fashion. The computer can be, for example, a personal computer, microcomputer, or workstation of conventional design.

Each program can be implemented in a high-level procedural or object-oriented programming language to communicate with a computer system. However, the programs can be implemented in assembly or machine language, if desired. In any case, the language can be a compiled or interpreted language. Each such computer program is preferably stored on a storage media or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

The signature patterns and databases thereof can be provided in a variety of media to facilitate their use. “Media” refers to a manufacture that contains the signature pattern information of an embodiment. The databases of some embodiments can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; remote servers; and hybrids of these categories such as magnetic/optical storage media. One of skill in the art can readily appreciate how any of the presently known computer readable mediums can be used to create computer readable media comprising a recording of the present database information. “Recorded” refers to a process for storing information on computer readable medium, using any such methods as known in the art. Any convenient data storage structure can be chosen, based on the means used to access the stored information. A variety of data processor programs and formats can be used for storage, e.g., word processing text file, database format, etc.

In some embodiments, the methods described herein, including the methods for optimizing a press cycle, are performed on one or more computers in a distributed computing system environment (e.g., in a cloud computing environment). In this description, “cloud computing” is defined as a model for enabling on-demand network access to a shared set of configurable computing resources. Cloud computing can be employed to offer on-demand access to the shared set of configurable computing resources. The shared set of configurable computing resources can be rapidly provisioned via virtualization and released with low management effort or service provider interaction, and then scaled accordingly. A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 4 illustrates an example computer for implementing the entities shown in FIGS. 1, 3, and 7. The computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, an input device 414, and network adapter 416 are coupled to the I/O controller hub 422. Other embodiments of the computer 400 have different architectures.

The storage device 408 is a non-transitory computer-readable storage medium such as a hard drive, compact disk read-only memory (CD-ROM), DVD, or a solid-state memory device. The memory 406 holds instructions and data used by the processor 402. The input interface 414 is a touch-screen interface, a mouse, track ball, or other type of pointing device, a keyboard, or some combination thereof, and is used to input data into the computer 400. In some embodiments, the computer 400 may be configured to receive input (e.g., commands) from the input interface 414 via gestures from the user. The network adapter 416 couples the computer 400 to one or more computer networks. In other embodiments the computer 400 receives input commands from a remote device (smart phone, tablets or other similar devices) connected to the internet.

The graphics adapter 412 displays images and other information on the display 418. In various embodiments, the display 418 is configured such that the user may (e.g., operator, user, winemaker, or other personnel as described herein) may input user selections on the display 418. In one embodiment, the display 418 may include a touch interface.

The computer 400 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 408, loaded into the memory 406, and executed by the processor 402.

The types of computers 400 used by the entities of FIGS. 1, 3, and 7 can vary depending upon the embodiment and the processing power required by the entity. For example, the processor 108 can run in a single computer 400 or multiple computers 400 communicating with each other through a network such as in a server farm. The computers 400 can lack some of the components described above, such as graphics adapters 412, and displays 418.

Machine Learning Algorithm

In some embodiments, the processor applies one or more algorithms or predictive models to optimize a press cycle, based on parameters of the juice extract (as described herein). In some embodiments, each algorithm may correspond to identifying optimal press cut threshold values and/or press conditions for a given desired quality and/or characteristics of the finished product. In some embodiments, the one or more processors apply algorithms (e.g., algorithms embodied in trained models) to correlate the various combinations of parameters of the juice extract and/or press conditions (as described herein). In some embodiments, at least one of the one or more algorithms may comprise a machine learning algorithm incorporating artificial intelligence (AI) to help determine and optimize a press cycle, as described herein. For example, in some embodiments, said artificial intelligence is applied to trained model data (which may be included in the decision engine data) and optionally existing press cycle data (such as historical press cycle data correlating parameters of a juice extract, characteristics of a fruit and/or vegetable harvest (e.g., type of fruit, date of harvest, time since harvest, fermentation, etc.), fruit or vegetable growing conditions (e.g., irrigation, fertilization, pest control actions, weather (e.g., using weather station data), fermentation factors, and/or conditions of the press) to identify the parameters of the juice extract and/or the press conditions for optimizing the quality and efficiency of the press cycle, thereby training the model. In some embodiments, data obtained during a press cycle can be integrated for improved decision making, improved quality and productivity and efficiency in the press utilization. In some cases the information gathered during the press cycle is shared and analyzed in conjunction with data obtained before and/or after the pressing of the fruit. Making the fruit juice data visible upstream and downstream the pressing equipment enables, in some cases, higher level optimization and improved quality of the finished product, while maximizing the productivity across the entire value chain.

In some embodiments, any one of the decision engine(s) described herein is any one of a regression model (e.g., linear regression, logistic regression, or polynomial regression), decision tree, random forest, gradient boosted machine learning model, support vector machine, Naïve Bayes model, k-means cluster, or neural network (e.g., feed-forward networks, convolutional neural networks (CNN), deep neural networks (DNN), autoencoder neural networks, generative adversarial networks, or recurrent networks (e.g., long short-term memory networks (LSTM), bi-directional recurrent networks, deep bi-directional recurrent networks), or any combination thereof. In particular embodiments, any one of the decision engine(s) described herein is a logistic regression model. In particular embodiments, any one of the decision engine(s) described herein is a random forest classifier. In particular embodiments, any one of the decision engine(s) described herein is a gradient boosting model.

In some embodiments, any one of the decision engine(s) described herein (e.g., a trained model) can be trained using a machine learning implemented method, such as any one of a linear regression algorithm, logistic regression algorithm, decision tree algorithm, support vector machine classification, Naïve Bayes classification, K-Nearest Neighbor classification, random forest algorithm, deep learning algorithm, gradient boosting algorithm, and dimensionality reduction techniques such as manifold learning, principal component analysis, factor analysis, autoencoder regularization, and independent component analysis, or combinations thereof. In particular embodiments, the machine learning implemented method is a logistic regression algorithm. In particular embodiments, the machine learning implemented method is a random forest algorithm. In particular embodiments, the machine learning implemented method is a gradient boosting algorithm, such as XGboost. In some embodiments, any one of the trained model(s) described herein is trained using supervised learning algorithms, unsupervised learning algorithms, semi-supervised learning algorithms (e.g., partial supervision), weak supervision, transfer, multi-task learning, or any combination thereof.

In some embodiments, any one of the trained model(s) described herein has one or more parameters, such as hyperparameters or model parameters. Hyperparameters are generally established prior to training. Examples of hyperparameters include the learning rate, depth or leaves of a decision tree, number of hidden layers in a deep neural network, number of clusters in a k-means cluster, penalty in a regression model, and a regularization parameter associated with a cost function. Model parameters are generally adjusted during training. Examples of model parameters include weights associated with nodes in layers of neural network, support vectors in a support vector machine, node values in a decision tree, and coefficients in a regression model.

In some embodiments, any one of the trained model(s) described herein are trained via training data located in the trained model data (which may be in communication with the processor 108).

In various embodiments, the training data used for training any one of the trained model(s) described herein includes reference ground truths that indicate one or more press conditions associated with a desired press cut(s) (hereafter also referred to as “positive” or “+”) or whether one or more press conditions were not associated with a desired press cut(s) (hereafter also referred to as “negative” or “−”). In various embodiments, the reference ground truths in the training data are binary values, such as “1” or “0.” For example, one or more press conditions associated with a desired press cut(s) can be identified in the training data with a value of “1” whereas one or more press conditions not associated with a desired press cut(s) can be identified in the training data with a value of “O.” In various embodiments, any one of the trained model(s) described herein are trained using the training data to minimize a loss function such that any one of the trained model(s) described herein can better predict the outcome (e.g., quality of press cuts) based on the input (e.g., one or more press conditions, characteristics of a juice, etc.). In some embodiments, the loss function is constructed for any of a least absolute shrinkage and selection operator (LASSO) regression, Ridge regression, or ElasticNet regression. In some embodiments, any one of the trained model(s) described herein is a random forest model, and is trained to minimize one of Gini impurity or Entropy metrics for feature splitting, thereby enabling any one of the trained model(s) described herein to better optimize the quality and/or efficiency of a press cycle.

In various embodiments, the training data can be obtained and/or derived from a publicly available database. In some embodiments, the training data can be obtained and collected independent of publicly available databases. Such training data can be a custom dataset.

In some embodiments, historical juice data from current and prior harvests, laboratory results from the actual juice analysis, other current or past harvest data (which may include, for example, fruit or vegetable characteristics prior to extraction, which may be based at least partly due to weather, environmental, and other conditions as known in the art), and information from juice post processing as obtained via the system 100 is stored in the computing system (e.g., see FIG. 4) and in communication (and accessible) with the processor. In some embodiments, the historical data includes historical press cycle data correlating parameters of a juice extract, characteristics of a fruit or vegetable harvest (e.g., type of fruit, date of harvest, time since harvest, fermentation, etc.), and/or conditions of the press) to identify the parameters of the juice extract and/or the press conditions for optimizing the quality and efficiency of the press cycle. In some embodiments, the historical data is updated via communication with an external database (including other internet sources), and/or is updated based on parameters and/or conditions inputted by the operator.

Disclosed herein, in some aspects, is a system for optimizing a press cycle for producing one or more press cuts from a fruit and/or vegetable harvest, the system comprising: a press configured to extract a fluid from a batch of a fruit and/or vegetable harvest; a flow path in fluidic communication with the press and configured to receive the extracted fluid; one or more flow sensors disposed within and/or about the flow path and configured to detect and obtain measurements of one or more parameters of the extracted fluid; and at least one processor in operative communication with the one or more flow sensors and configured to determine, based on the measurements, at least one of: i) that a threshold value corresponding to a press cut segregation point has been reached, or ii) one or more conditions for operating the press to produce at least one press cut.

### Exemplary Embodiments

Disclosed herein, in some aspects, is a method for optimizing a press cycle for producing one or more press cuts from a fruit and/or vegetable harvest, the method comprising: using a press to extract a fluid from a batch of a fruit and/or vegetable harvest; receiving the extracted fluid within a flow path in fluidic communication with the press; measuring one or more parameters in the extracted fluid using one or more flow sensors; providing the measurements of the one or more parameters to at least one processor; and determining, using the at least one processor and based on the measurements, at least one of: i) that a threshold value corresponding to a press cut segregation point has been reached, or ii) one or more conditions for operating the press to produce at least one press cut.

In some embodiments, the one or more parameters comprise pH, conductivity, turbidity, color, temperature, flow rate, or any combination thereof. In some embodiments, the threshold value comprises a pH level, a turbidity, a chemical quality, or any combination thereof. In some embodiments, the chemical quality comprises a phenolic concentration of the extracted fluid, wherein the at least one processor is configured to determine the phenolic concentration based on at least one of the measurements. In some embodiments, the one or more conditions comprises a pressure during a press cycle, a rotation interval of the press during the press cycle, a pressure dwell time during the press cycle, a size of increasing pressure increments, or any combination thereof.

In some embodiments, the at least one processor is configured to detect an abnormality associated with the extracted fluid, and identify one or more actions for mitigating the abnormality. In some embodiments, the abnormality comprises high redox in the extracted fluid. In some embodiments, the one or more actions comprises adding sulphur dioxide to the extracted fluid in the flow path and/or in the press.

In some embodiments, wherein any system described herein further comprises one or more press sensors in operative communication with the at least one processor and configured to detect one or more current conditions of the press. In some embodiments, the at least one processor is configured to determine, based on the measurements, an adjustment to the one or more conditions in real time. In some embodiments, the one or more conditions comprises an operating pressure of the press. In some embodiments, the at least one processor uses a machine learning algorithm to determine the one or more conditions.

In some embodiments, the flow path comprises at least one of a pipe, a tube, a container, a duct, or any combination thereof. In some embodiments, at least one flow sensor of the one or more flow sensors is coupled to a wall defining the flow path. In some embodiments, at least one flow sensor of the one or more flow sensors contacts the extracted fluid within the flow path.

In some embodiments, wherein any system described herein further comprises a user interface in communication with the at least one processor and configured to receive input from an operator, the input including the threshold value. In some embodiments, the extracted fluid comprises a liquid, a liquid-solid mixture, a liquid-solid-gas mixture, or any combination thereof. In some embodiments, the fruit and/or vegetable harvest comprises grapes, plum, pomegranate, wine, pumpkin, kiwi, potatoes, carrots, strawberry, raspberry, blueberry, other berries, or any combination thereof. In some embodiments, the at least one processor is configured to determine that the threshold value corresponding to the press cut segregation point has been reached. In some embodiments, the at least one processor is configured to determine the one or more conditions for operating the press to produce the at least one press cut.

Disclosed herein, in some aspects, is a method for optimizing a press cycle for producing one or more press cuts from a fruit and/or vegetable harvest, the method comprising: using a press to extract a fluid from a batch of a fruit and/or vegetable harvest; receiving the extracted fluid within a flow path in fluidic communication with the press; measuring one or more parameters in the extracted fluid using one or more flow sensors; providing the measurements of the one or more parameters to at least one processor; and determining, using the at least one processor and based on the measurements, at least one of: i) that a threshold value corresponding to a press cut segregation point has been reached, or ii) one or more conditions for operating the press to produce at least one press cut.

In some embodiments, the one or more parameters comprises pH, conductivity, turbidity, color, temperature, flow rate, or any combination thereof. In some embodiments, the threshold value comprises a pH level, a turbidity, a chemical quality, or any combination thereof. In some embodiments, wherein any method described herein further comprises determining, using the at least one processor, a chemical quality in the extracted fluid based on the measurements. In some embodiments, the chemical quality comprises a phenolic concentration of the extracted fluid.

In some embodiments, the one or more conditions comprises a pressure during a press cycle, a rotation interval of the press during the press cycle, a pressure dwell time during the press cycle, a size of increasing pressure increments, or any combination thereof. In some embodiments, wherein any method described herein further comprises detecting, using the at least one processor, an abnormality associated with the extracted fluid, and identifying one or more actions for mitigating the abnormality. In some embodiments, the abnormality comprises high redox in the extracted fluid. In some embodiments, the one or more actions comprises adding sulphur dioxide to the extracted fluid in the flow path and/or the press.

In some embodiments, wherein any method described herein further comprises detecting one or more current conditions of the press using one or more press sensors in operative communication with the at least one processor. In some embodiments, wherein any method described herein further comprises determining, using the at least one processor and based on the measurements, an adjustment to the one or more conditions in real time.

In some embodiments, the at least one processor uses a machine learning algorithm to determine the one or more conditions. In some embodiments, the flow path comprises at least one of a pipe, a tube, a container, a duct, or any combination thereof. In some embodiments, at least one flow sensor of the one or more flow sensors is coupled to a wall defining the flow path. In some embodiments, at least one flow sensor of the one or more flow sensors contacts the extracted fluid within the flow path. In some embodiments, wherein any method described herein further comprises receiving input from an operator via a user interface, the input including the threshold value.

In some embodiments, the extracted fluid comprises a liquid, a liquid-solid mixture, a liquid-solid-gas mixture, or any combination thereof. In some embodiments, the fruit and/or vegetable harvest comprises grapes, plum, pomegranate, wine, pumpkin, kiwi, potatoes, carrots, strawberry, raspberry, blueberry, other berries, or any combination thereof. In some embodiments, the method comprises determining, using the at least one processor and based on the measurements, that the threshold value corresponding to a press cut segregation point has been reached. In some embodiments, the method comprises determining, using the at least one processor and based on the measurements, one or more conditions for operating the press to produce at least one press cut.

All publications, patents, patent applications and other documents cited in this application are hereby incorporated by reference herein in their entireties for all purposes to the same extent as if each individual publication, patent, patent application or other document were individually indicated to be incorporated by reference for all purposes.

While various specific embodiments have been illustrated and described, the above specification is not restrictive. It will be appreciated that various changes can be made without departing from the spirit and scope of the present disclosure(s). Many variations will become apparent to those skilled in the art upon review of this specification.

What is claimed is:

1. A system for optimizing a press cycle for producing one or more press cuts from a fruit and/or vegetable harvest, the system comprising:
a. a press configured to extract a fluid from a batch of a fruit and/or vegetable harvest;
b. a flow path in fluidic communication with the press and configured to receive the extracted fluid;
c. one or more flow sensors disposed within and/or about the flow path and configured to detect and obtain measurements of one or more parameters of the extracted fluid; and
d. at least one processor in operative communication with the one or more flow sensors and configured to determine, based on the measurements, at least one of:
i) that a threshold value corresponding to a press cut segregation point has been reached, or ii) one or more conditions for operating the press to produce at least one press cut.

2. The system of claim 1, wherein the one or more parameters comprise pH, conductivity, turbidity, color, temperature, flow rate, or any combination thereof.

3. The system of claim 1, wherein the threshold value comprises a pH level, a turbidity, a chemical quality, or any combination thereof.

4. The system of claim 3, wherein the chemical quality comprises a phenolic concentration of the extracted fluid, wherein the at least one processor is configured to determine the phenolic concentration based on at least one of the measurements.

5. The system of claim 1, wherein the one or more conditions comprises a pressure during a press cycle, a rotation interval of the press during the press cycle, a pressure dwell time during the press cycle, a size of increasing pressure increments, or any combination thereof.

6. The system of claim 1, wherein the at least one processor is configured to detect an abnormality associated with the extracted fluid, and identify one or more actions for mitigating the abnormality.

7. The system of claim 6, wherein the abnormality comprises high redox in the extracted fluid.

8. The system of claim 6, wherein the one or more actions comprises adding sulphur dioxide to the extracted fluid in the flow path and/or in the press.

9. The system of claim 1, further comprising one or more press sensors in operative communication with the at least one processor and configured to detect one or more current conditions of the press.

10. The system of claim 1, wherein the at least one processor is configured to determine, based on the measurements, an adjustment to the one or more conditions in real time.

11. The system of claim 1, wherein the one or more conditions comprises an operating pressure of the press.

12. The system of claim 1, wherein the at least one processor uses a machine learning algorithm to determine the one or more conditions.

13. The system of claim 1, wherein the flow path comprises at least one of a pipe, a tube, a container, a duct, or any combination thereof.

14. The system of claim 1, wherein at least one flow sensor of the one or more flow sensors is coupled to a wall defining the flow path.

15. The system of claim 1, wherein at least one flow sensor of the one or more flow sensors contacts the extracted fluid within the flow path.

16. The system of claim 1, further comprising a user interface in communication with the at least one processor and configured to receive input from an operator, the input including the threshold value.

17. The system of claim 1, wherein the extracted fluid comprises a liquid, a liquid-solid mixture, a liquid-solid-gas mixture, or any combination thereof.

18. The system of claim 1, wherein the fruit and/or vegetable harvest comprises grapes, plum, pomegranate, wine, pumpkin, kiwi, potatoes, carrots, strawberry, raspberry, blueberry, other berries, or any combination thereof.

19. The system of claim 1, wherein the at least one processor is configured to determine that the threshold value corresponding to the press cut segregation point has been reached.

20. The system of claim 1, wherein the at least one processor is configured to determine the one or more conditions for operating the press to produce the at least one press cut.

21. A method for optimizing a press cycle for producing one or more press cuts from a fruit and/or vegetable harvest, the method comprising:
a. using a press to extract a fluid from a batch of a fruit and/or vegetable harvest;
b. receiving the extracted fluid within a flow path in fluidic communication with the press;
c. measuring one or more parameters in the extracted fluid using one or more flow sensors;
d. providing the measurements of the one or more parameters to at least one processor; and
e. determining, using the at least one processor and based on the measurements, at least one of: i) that a threshold value corresponding to a press cut segregation point has been reached, or ii) one or more conditions for operating the press to produce at least one press cut.

22. The method of claim 21, wherein the one or more parameters comprises pH, conductivity, turbidity, color, temperature, flow rate, or any combination thereof.

23. The method of claim 21, wherein the threshold value comprises a pH level, a turbidity, a chemical quality, or any combination thereof.

24. The method of claim 21, further comprising determining, using the at least one processor, a chemical quality in the extracted fluid based on the measurements.

25. The method of claim 24, wherein the chemical quality comprises a phenolic concentration of the extracted fluid.

26. The method of claim 21, wherein the one or more conditions comprises a pressure during a press cycle, a rotation interval of the press during the press cycle, a pressure dwell time during the press cycle, a size of increasing pressure increments, or any combination thereof.

27. The method of claim 21, further comprising detecting, using the at least one processor, an abnormality associated with the extracted fluid, and identifying one or more actions for mitigating the abnormality.

28. The method of claim 27, wherein the abnormality comprises high redox in the extracted fluid.

29. The method of claim 27, wherein the one or more actions comprises adding sulphur dioxide to the extracted fluid in the flow path and/or the press.

30. The method of claim 21, further comprising detecting one or more current conditions of the press using one or more press sensors in operative communication with the at least one processor.

31. The method of claim 21, further comprising determining, using the at least one processor and based on the measurements, an adjustment to the one or more conditions in real time.

32. The method of claim 21, wherein the at least one processor uses a machine learning algorithm to determine the one or more conditions.

33. The method of claim 21, wherein the flow path comprises at least one of a pipe, a tube, a container, a duct, or any combination thereof.

34. The method of claim 21, wherein at least one flow sensor of the one or more flow sensors is coupled to a wall defining the flow path.

35. The method of claim 21, wherein at least one flow sensor of the one or more flow sensors contacts the extracted fluid within the flow path.

36. The method of claim 21, further comprising receiving input from an operator via a user interface, the input including the threshold value.

37. The method of claim 21, wherein the extracted fluid comprises a liquid, a liquid-solid mixture, a liquid-solid-gas mixture, or any combination thereof.

38. The method of claim 21, wherein the fruit and/or vegetable harvest comprises grapes, plum, pomegranate, wine, pumpkin, kiwi, potatoes, carrots, strawberry, raspberry, blueberry, other berries, or any combination thereof.

39. The method of claim 21, wherein the method comprises determining, using the at least one processor and based on the measurements, that the threshold value corresponding to a press cut segregation point has been reached.

40. The method of claim 21, wherein the method comprises determining, using the at least one processor and based on the measurements, one or more conditions for operating the press to produce at least one press cut.
